(19) United States
(12) Patent Application Publication
(10) Pub. No.: US 2024/0383139 A1
(43) Pub. Date: Nov. 21, 2024

(54) Robotic Multi-Line Picking

(71) Applicant: Staples, Inc., Framingham, MA (US)

(72) Inventors: Matthew Robert Douglas, Orlando, FL (US); Paolo Gerli, Westborough, MA (US); Gregory Patrick Cox, Sleepy Hallow, NY (US); Amit Kalra, Acton, MA (US); Brandon Lam, Rockland, MA (US); Ruchi Tewari, Hopkinton, MA (US); Daniel Jarvis, Holliston, MA (US); Nikhil Variar, Needham, MA (US); Naveen Challapalli, Cambridge, MA (US)

(21) Appl. No.: 18/669,358

(22) Filed: May 20, 2024

Related U.S. Application Data
(60) Provisional application No. 63/503,414, filed on May 19, 2023.

(51) Int. Cl. B25J 9/16; B25J 5/02; B25J 9/00; B25J 11/00

(52) U.S. Cl. CPC B25J 9/1664; B25J 5/02; B25J 9/0093; B25J 11/005

(57) ABSTRACT

A system may transport a first set of mobile storage units from a storage area to an active picking bay of a robotic picking station, the robotic picking station including a robotic arm, the active picking bay being within a range of motion of the robotic arm. A system may transport a carton to the robotic picking station, for example, using one or more conveyors. A system may instruct the robotic arm to move a first item from the first set of mobile storage units into the carton. A system may transport the carton out of the robotic picking station.

### BACKGROUND

This application relates to warehouse fulfillment systems. For example, this application relates to an automated system for picking items into containers, for example, where items are automatedly picked into a shipping carton using a robotic arm.

Existing systems for fulfilling orders pick items into containers one-by-one, often using human pickers that seek out items in a warehouse and then place them into containers. Human-based systems result in errors, fatigue, and increased task completion time.

Previous robotic-assisted picking essentially required transporting entire shelving units with several shelves within a facility. In these technologies, a robot would bring the shelving unit to a human picker that uses the shelving unit to fulfill orders. Unfortunately, these systems require significant space and resources, fail to maintain a continuous stream of items to the picker, are not adjustable, and waste resources through excessive shuffling of items. Furthermore, these systems require excessive square footage in a facility, which may be used otherwise for item storage or otherwise.

### SUMMARY

A robotic arm picking system can be configured to perform particular operations or actions by virtue of having software, firmware, hardware, or a combination of them installed on the system that in operation causes or cause the system to perform the actions. In some aspects, the techniques described herein relate to a computer-implemented method including: transporting, by one or more processors, a first set of mobile storage units from a storage area to an active picking bay of a robotic picking station, the robotic picking station including a robotic arm, the active picking bay being within a range of motion of the robotic arm; transporting, by the one or more processors, a carton to the robotic picking station; instructing, by the one or more processors, the robotic arm to move a first item from the first set of mobile storage units into the carton; and transporting, by the one or more processors, the carton out of the robotic picking station.

In some aspects, the techniques described herein relate to a computer-implemented method, further including: determining an order containing one or more items in the first set of mobile storage units, the one or more items including the first item; and associating the order with an identifier of the carton based on the first item.

In some aspects, the techniques described herein relate to a computer-implemented method, wherein transporting the first set of mobile storage units from the storage area to the active picking bay of the robotic picking station includes: transporting, by one or more automated guided vehicles, a second set of mobile storage units from the storage area to a staging area nearer to the active picking bay than the storage area, the staging area being outside the range of motion of the robotic arm; and transporting, by the one or more automated guided vehicles, the first set of mobile storage units from the staging area to the active picking bay, the first set of mobile storage units being a subset of the second set of mobile storage units.

In some aspects, the techniques described herein relate to a computer-implemented method, wherein: transporting the carton to the robotic picking station includes transporting an unassigned carton to a carton receiving area at the robotic picking station using one or more conveyors; and the method includes: identifying a carton identifier on the unassigned carton upon the unassigned carton arriving at the carton receiving area of the robotic picking station; and assigning the unassigned carton to an order associated with the first item using the robotic arm, the carton receiving the first item being the previously unassigned carton.

In some aspects, the techniques described herein relate to a computer-implemented method, further including: after transporting the carton out of the robotic picking station, scanning the carton identifier and determining the order assigned to the carton; and automatically printing a shipping label associated with the order for the carton based on the scan.

In some aspects, the techniques described herein relate to a computer-implemented method, wherein transporting the carton to the robotic picking station includes: placing the carton on a first conveyor at a carton erector; and moving the carton from the first conveyor to the carton receiving area using a second conveyor.

In some aspects, the techniques described herein relate to a computer-implemented method, wherein transporting the carton out of the robotic picking station includes: reversing a direction of the second conveyor to move the carton from the carton receiving area to a third conveyor; and transporting the carton away from the robotic picking station using the third conveyor.

In some aspects, the techniques described herein relate to a computer-implemented method, further including: determining a set of orders associated with a set of items; the set of items being stored in the storage area in the first set of mobile storage units; selecting an order from the set of orders containing the first item and associating the order with the carton at the robotic picking station; and instructing the robotic arm to move a second item associated with the selected order from the first set of mobile storage units into the carton.

In some aspects, the techniques described herein relate to a computer-implemented method, further including: scanning the carton at a carton receiving area adjacent to the robotic arm; scanning the first item retrieved from a first mobile storage unit; confirming an identity of the first item based on the scan of the first item; and instructing the robotic arm to place the first item into the carton based on confirming the identity of the first item.

In some aspects, the techniques described herein relate to a system including: a robotic arm; one or more active picking bays within a range of motion of the robotic arm, the one or more active picking bays supplying a first item to be picked by the robotic arm; a carton receiving area that holds a carton, the robotic arm being configured to pick the first item from the one or more active picking bays and place the first item into the carton in the carton receiving area; and one or more conveyors conveying the carton to the carton receiving area and conveying the carton from the carton receiving area after the carton has received the first item using the robotic arm.

In some aspects, the techniques described herein relate to a system, further including: a staging area holding one or more mobile storage units as a buffer for the one or more active picking bays, at least a portion of the staging area being outside the range of motion of the robotic arm.

In some aspects, the techniques described herein relate to a system, further including: a storage area storing the one or more mobile storage units, the storage area being farther away from the robotic arm than the staging area.

In some aspects, the techniques described herein relate to a system, further including: one or more automated guided vehicles moving the one or more mobile storage units between the storage area and the staging area.

In some aspects, the techniques described herein relate to a system, wherein: the one or more automated guided vehicles further move the one or more mobile storage units between the staging area and the one or more active picking bays.

In some aspects, the techniques described herein relate to a system, wherein the one or more conveyors include: a first conveyor conveying the carton to the carton receiving area; and a second conveyor conveying the carton from the carton receiving area to a finalizing area.

In some aspects, the techniques described herein relate to a system, wherein the one or more conveyors include: a third conveyor conveying the carton from the first conveyor to the carton receiving area, the third conveyor being reversible to move the carton away from the carton receiving area.

In some aspects, the techniques described herein relate to a system, further including: one or more scanners at the carton receiving area, the one or more scanners scanning a carton identifier on the carton to identify the carton at the carton receiving area.

In some aspects, the techniques described herein relate to a system, wherein the one or more active picking bays include: a first shelf on a first side of the robotic arm holding a first mobile storage unit, the first mobile storage unit storing a first plurality of items; and a second shelf on a second side of the robotic arm holding a second mobile storage unit, the second mobile storage unit holding a second plurality of items.

In some aspects, the techniques described herein relate to a system, wherein: the one or more active picking bays include two or more shelves each holding a mobile storage unit within the range of motion of the robotic arm, the two or more shelves being horizontally located adjacent to each other; and a plurality of vertically oriented shelves adjacent to the two or more shelves, the plurality of vertically oriented shelves holding a plurality of mobile storage units outside of the range of motion of the robotic arm.

In some aspects, the techniques described herein relate to a system including: one or more processors; and a non-transitory memory storing instructions that, when executed by the one or more processors cause the system to perform operations including: transporting a first set of mobile storage units from a storage area to an active picking bay of a robotic picking station, the robotic picking station including a robotic arm, the active picking bay being within a range of motion of the robotic arm; transporting a carton to the robotic picking station; instructing the robotic arm to move a first item from the first set of mobile storage units into the carton; and transporting the carton out of the robotic picking station.

Other implementations of one or more of these aspects include corresponding systems, apparatus, and computer programs, configured to perform the actions of the methods, encoded on computer storage devices.

It should be understood that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 depicts an example system and data communication flow for implementing an automated robotic replenishment system.

FIGS. 2A-2C illustrate example configurations of an example robotic picking station.

FIGS. 3A-3C illustrate perspective views of example layouts of a picking system in which robotic picking stations are used.

FIGS. 4A-4E illustrate various configurations of robotic picking stations and fulfillment center layouts.

FIG. 5 illustrates an example layout of a facility in which one or more robotic arm picking stations are used along with example paths of items, mobile storage units, and cartons.

FIG. 6 is a flowchart of an example method for picking items using a robotic picking station.

FIG. 7 is a block diagram illustrating an example computing system.

### DESCRIPTION

The invention improves multi-line picking in a robotic environment. For instance, previous systems required human picking while the current invention provides a potentially completely automated picking system, which may be used to pick multiple different items into cartons 218. The system reduces the space required by other manual and robotic picking systems using its configuration, operations, and features.

Accordingly, because previous systems were slow, processing-intensive, not robust and often require manual intervention, among other issues, the technologies described herein provide numerous improvements. For example, the technologies herein may be applied in a fully or partially automated fulfillment center where slow, inaccurate, or non-robust operations can compound to cause significant delays and errors in ways that address these issues. The technology described herein may be used in an automatic, robotic replenishment, organizing, or fulfillment system in a warehouse. For instance, the technology described herein may be applied in various robotic contexts where items are picked from mobile storage units 216 into shipping cartons 218 using robotic device(s).

The technology described herein relates to an automated system comprising various software and hardware devices, for example, an automated robotic picking system. The technology may include beneficial configurations, operations, features, and interactions. Among other benefits, the technology described herein improves upon that described above. For instance, the technology provides robotic devices, systems, methods, and other aspects that can more efficiently process goods (e.g., items or items in a distribution facility).

Robotic order fulfilment implemented in the fulfillment center may use a robotic arm 140 or other handling mechanism that picks the SKUs (stock keeping units or types of items) from a (e.g., one of the four) pick location around it. In some implementations, for purposes of accurate counting or item placement, the work-flow architecture may cause a robotic arm 140 to pick up one SKU out of a bin and drop it into a carton 218 that is presented using a conveyor 222 system.

In some implementations, the technology may use a robotic arm 140 222 and/or various other devices that handle items. For instance, a fulfillment center may use storage units, conveyors 222, or other devices that hold or move various types of items and from which the items may be picked to fulfill orders, such as by removing items from the storage units and placing them into shipping boxes. In other implementations, the items may be moved from pallets into storage units or otherwise robotically handled.

In some implementations, the technology may provide integration, coordination, and control of various systems to intelligently move items and reduce human interaction, which increases speed and accuracy.

In some instances, the technology may include various computing devices or controllers coupled with equipment, such as the robotic arm(s) 140, sensors 142, AGV(s) 114, other equipment 144, sensors (e.g., optical sensors, scanners, etc.) human interface system(s) 108, and other devices. In some implementations, the components may communicate with each other directly, for instance, via a network or communication bus. In some implementations, a central control system, such as a warehouse management system (WMS) 104, warehouse execution system (WES) 102, robot execution server (REX) 118, or other system may receive signals, perform computations, and issue commands to other devices.

The robotic arm(s) 140, sensor(s) 142, and other devices are described in further detail below.

These and other technologies described herein provide numerous benefits, such as those described above, increasing operating hours, decreasing fatigue, and allowing the technology to scale rapidly, for example, over previous, manual methods.

Features of the technology described herein can be integrated into any logistics system, dispatch system, warehouse execution system, warehouse management system, a robot execution server, etc., to coordinate the operations of various systems, information, and devices in a fulfillment system. The technology described herein may provide a fully or partially automated system that provides redundancy, reduces the number of operations, and provides many other benefits described herein. The technology beneficially improves productivity and throughput, increases asset utilization, and lowers cycle time and labor costs. These benefits, in turn, lead to shorter delivery times and result in significant time and resource savings along with reduced error rates.

The technology may automate numerous operations, such as the coordinated pairing of otherwise un-associated systems, thereby providing the noted benefits, among others. The system may include various levels of control, for example, by providing system-level and/or device-level identification, processing, and/or control. It should be noted that these operations are provided as an illustrative example and many other operations and features are within the scope of the present disclosure.

With reference to the figures, reference numbers may be used to refer to components found in any of the figures, regardless of whether those reference numbers are shown in the figure being described. Further, where a reference number includes a letter referring to one of multiple similar components (e.g., component 000a, 000b, and 000n), the reference number may be used without the letter to refer to one or all of the similar components. Further, it should be noted that while various example features and implementations are described throughout this disclosure and the figures, these examples are not exhaustive of every contemplated implementation, feature or permutation. For instance, while a certain feature may be described in reference to a first implementation, the feature may be used with a second implementation or the features, operations, etc., may otherwise be exchanged between the implementations.

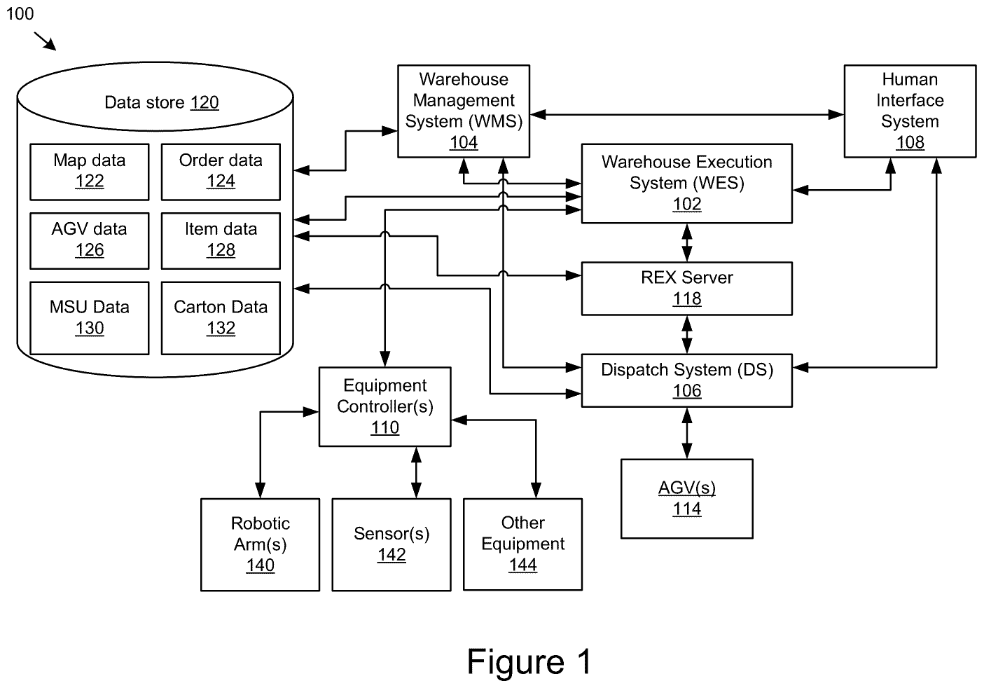

FIG. 1 depicts an example system 100 and data communication flow for implementing an automated robotic replenishment system. The system 100 includes a warehouse execution system (WES) 102. The WES 102 is coupled to equipment controller(s) 110, a warehouse management system (WMS) 104, a data store 120 storing various data, a human interface system 108 (e.g., pick-to-voice, pick-to-light, graphical user interface(s), etc.), a robot execution server (REX) 118, a dispatch system 106, and other systems. For instance, the system 100 may include robotic arm(s) 140 or other item positioning systems, sensor(s) 142, and/or other equipment 144, such as conveyors 222, robots, or other devices.

The WES 102 may, in some implementations, include one or more hardware and/or virtual servers programmed to perform operations, acts, and/or functionality described herein. For instance, the components of the WES 102 may comprise software routines storable in one or more non-transitory memory devices and executable by one or more computer processors of the WES 102 to carry out operations, acts, and/or functionality described herein. For instance, the robotic arms 140 or other positioning equipment, AGVs 114, conveyors 222, sensors, and/or other devices may send information to and receive instructions from the WES 102 (or WMS 104 or another device). In further implementations, these routines, or a portion thereof, may be embodied in electrical hardware that is operable to carry out the operations, acts, and/or functionality described herein.

For example, the WES 102 may be communicatively coupled with scanner(s), carton 218 conveyor(s) 222, item conveyor(s) 222, diverter(s), robotic arms 140, sensor(s) 142, and other equipment either directly or via the equipment controller(s) 110, which may be programmable logic controllers (e.g., conveyor 222 controllers, conveyor 222 scanner controllers, automated induction equipment controllers, other warehouse equipment controllers, or other computing devices for controlling equipment).

In some implementations, the WES 102 may receive, process, and transmit data to control software and hardware interactions, for example, by consolidating and controlling information across systems, as described herein. For instance, the WES 102 may serve as a decision point or control software that processes data streams for receiving data, processing the data, instructing devices, and other computations, as noted herein. For example, the WES 102 may communicate with equipment controller(s) 110 and/or other systems to receive sensor data, move items (e.g., using a conveyance device), control a robotic arm 140 222, move mobile storage units 216, or other operations. One or more of these operations may be performed via communication with various equipment of the system 100, as described in further detail herein. Accordingly, the WES 102 may provide unified communication that coordinates various systems.

The WES 102 and/or WMS 104 (together or separately) may communicate with various other systems and devices to perform its operations, as described herein, such as equipment controller(s) 110 and equipment. The WES 102 or WMS 104 may communicate with equipment or a human-interface system 108, which may provide operations for picking items, for instance.

The other equipment 144 may include a robotic picking station 202, box erectors 304, label applicators, scanners, picking equipment, or other devices for inducting or moving items, mobile storage units 216, cartons 218, or other objects in the system; scanners that may include optical, radio, or other scanners or sensors that scan items, containers, totes, mobile storage units 216, or cartons 218 to identify them; conveyors 222 that may include one or more conveyor 222 belts or other devices that convey objects (e.g., items, mobile storage units 216, cartons 218, or other objects), for instance, as described herein Other equipment 144 may include various other devices, such as label applicators, carton 218-closing equipment, control systems, printers, actuators, motors; or various other devices.

The REX server 118 may, in some implementations, include one or more hardware and/or virtual servers programmed to perform operations, acts, and/or functionality described herein. The REX server 118 may generate a schedule that defines the route for an AGV 114. For a given AGV 114, the REX server 118 may generate an AGV 114 schedule and transmit it to the dispatch system 106, which in turn deploys an AGV 114 according to the schedule or instruction, for instance. In some implementations, the dispatch system 106 instructs the AGV 114 to proceed through one or more areas of the distribution facility according to the schedule/instruction. The schedule of each of the AGVs 114 may be coordinated such that an optimal flow can be achieved.

In some implementations, the REX server 118 may include or may communicate with a routing engine, which may route AGVs 114 and/or objects (e.g., items, mobile storage units 216, etc.) in a fulfillment center. For instance, as described in further detail below, the REX server 118 may coordinate one or more AGVs 114 to move mobile storage units 216 between a high-density storage area and a staging area 210, and/or between staging area 210 and an active slot or position at a robotic picking station 202. Although various implementations are possible, a mobile storage unit 216 may include a movable storage container, such as a tote, pallet, or mini pallet that holds other items. The mobile storage unit 216 may be an open-top container with one or multiple divisions. The mobile storage units 216 may be stored on other shelving units, for example, in a high-density storage area that may have many shelves high, deep, and/or wide that each hold a mobile storage unit 216. A mobile storage unit 216 may have various shapes or interfaces that allow them to more easily be manipulated by robotic equipment, such as an arm, fork, or other handling equipment of an automated guided vehicle 114.

The dispatch system 106 may be electronically communicatively coupled to a plurality of automated guided vehicles 114 (AGVs 114). In some implementations, the dispatch system 106, or elements thereof, may be integrated with or communicatively coupled with the REX server 118. The dispatch system 106 includes hardware and software configured to dispatch the AGVs 114 and is coupled for communication the components of the system 100 to receive instructions and provide data. The dispatch system 106 may calculate a route to execute the task considering traffic and resources. In some cases, it adjusts the route or the task in order to make the route efficient.

The AGVs 114 may be robotic vehicles including drive units providing motive force for moving the AGVs 114 (and, in some instances, items, storage units, etc.), guidance systems for determining position of the AGVs 114 within the distribution facility, and equipment for carrying items. Some AGVs 114 may be attached to, include, or carry carts, which, in turn, carry items or storage units.

The WMS 104 may, in some implementations, include one or more hardware and/or virtual servers or software routines storable in one or more non-transitory memory devices and executable by one or more processors to perform operations, acts, and/or functionality described herein. The WMS 104 may be configured to store and maintain data in the data store 120. In some implementations, the WMS 104 may be configured to communicate with the WES 102, the human interface system 108, dispatch system 106, and/or other systems in real time, in batches, as requested by these components, etc. For example, the WMS 104 may receive data from an e-commerce or other server, process the data, and update various data in the data store 120 based on the order data. Similarly, the WMS 104 may detect and update inventory and other data.

It should be noted that operations described herein in reference to the WMS 104 may be performed by other devices or by other components of the system 100. Similarly, it should be noted that the operations described in reference the WMS 104 and the other components of the system 100 may be distributed or shifted among the components of the system without departing from the scope of this disclosure. For instance, some operations described in reference to the WMS 104 may be performed by the equipment controller(s) 110 or REX server 118, or some operations described in reference to the equipment controller(s) 110, REX server 118, or automated-replenishment station 202 may be performed by the WMS 104 or WES 102.

The human interface system 108 may, in some implementations, include one or more hardware and/or virtual servers or software routines storable in one or more non-transitory memory devices and executable by one or more processors to perform operations, acts, and/or functionality described herein. The human interface system 108 may provide instructions and/or receive data (e.g., scan data, user input, confirmations), for example, from human agents or operators (e.g., using barcode scanners, NFC, RFID or radio-frequency identification chips, or other sensors or input methods), as described in further detail below. An example human interface system 108 may include audio, illumination, or a graphical user interface system that receives inputs and/or provides instructions to human agents. The human interface system 108 may be configured to communicate the pick confirmation data with the WES 102, WMS 104, or other components of the system in real time, in batches, as requested by the components of the system, etc.

The human interface system 108 may receive scan data from a client device based on a user scanning a barcode or other identifier of an item, conveyance device, tote, etc. The human interface system 108 may provide instructions to users indicating to place certain items, totes, containers, mobile storage units 216, etc., at certain locations, remedy errors or exceptions, or perform other actions. For instance, the human interface system 108 may instruct a user to remedy an error at an automated-robotic picking station 202 or AGV 114 or perform other actions.

The data store 120 is an information source for storing and providing access to data. The data stored by the data store 120 may be organized and queried using various criteria including any type of data stored by it. The data store 120 may include data tables, databases, or other organized collections of data. An example of the types of data stored by the data store 120 may include, but is not limited to map data 122, order data 124, AGV 114 data 126, item data 128, MSU (mobile storage unit 216) data 130, carton 218 data 132, or other data. In some instances, the data store 120 may also include system attributes, sensor data, etc.

The data store 120 may be included in the WES 102, WMS 104, REX server 118, or in another computing system and/or storage system distinct from but coupled to or accessible by the WES 102, WMS 104, REX server 118, or other components of the system 100. The WES 102, WMS 104, human interface system 108, REX server 118, and/or dispatch system 106, for example, may store and maintain data in the data store 120. The data store 120 can include one or more non-transitory computer-readable mediums for storing the data. In some implementations, the data store 120 may store data associated with a database management system (DBMS) operable on a computing system. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

The map data 122 may include data reflecting the 2- or 3-dimensional layout of the facility including example locations of storage units, automated-robotic picking stations 202, container receiving areas/spaces, mobile storage unit 216 receiving area/spaces, carton receiving area(s) 206, equipment, storage shelving units, items, AGVs 114, conveyors 222, etc. Map data 122 may indicate the attributes of the distribution facility, including attributes of zones/areas of a warehouse. For example, attributes of zones may include the number, quantity, and location of shelving units or bays, storage units, items, guidance system locators or markers, etc.

The order data 124 may include data about orders, such as the items in the orders, quantities of items, shipping priority of an order, similarity to other orders, size of a shipping carton 218 for the order, quantity of cartons 218 for an order, or other details.

The AGV 114 data 126 may describe the state of an AGV 114, such as operational state, health, location, battery life, storage capacity, objects (e.g., items, mobile storage units 216, totes, pallets, etc.) being carried, cartons 218, pending assignment (e.g., an assigned task), time until availability for an assignment, assignment queue, whether a picker is assigned to it, etc.

The item data 128 may describe items in a distribution facility. The item data 128 may include unique identifiers for these items, the item volume (e.g., the total amount picked in given window (e.g., in an hour, day, etc.)), the item velocity (e.g., number of different times item picked in given window (e.g., per hour, day etc.), the location of the items within the distribution facility (aisle, shelf, shelf position, mobile storage unit 216, mobile storage unit 216 partition, tote, conveyance device, pallet, etc.), other attributes of the item (e.g., size, description, weight, quantity of items in a package, color, quantity of packages in a container, etc.), item inventory, or mapping of items to stationary or mobile storage units 216, orders, conveyor 222 locations, automated-robotic picking stations 202, totes, etc. In some implementations, the item data 128 may include the quantity of particular items a storage unit contains, the current location of a storage unit, a storage location of items and/or storage units, and other data. For instance, the item data 128 may include visual aspects, labels, QR codes, identifying markers, etc., that may be used by the WES 102, WMS 104, or equipment controller(s) 110, etc., to identify items, for example, based on a scan of an item.

In some implementations, the item data 128 may include identifications and/or attributes of sets of items, for example, in a mobile storage unit 216, in an order, on a pallet, carried by an AGV 114, carried by a conveyor 222, etc. The item data may include item dimensions, such as the maximum or minimum height, width, length, etc., of an item. In some instances, the item data may also identify a general shape (e.g., associated with the dimensions) of an item, for example, whether an item is cylindrical, cuboid, triangular, etc.

In some implementations, the data store 120 may include a set, series, queue, sequence, or other groups of orders that may be picked together, for instance, to allow as few mobile storage units 216 as possible to be used at a given robotic picking station 202. For instance, orders containing the same or similar set of items may be processed sequentially at a robotic picking station 202 in order to reduce shuffling of mobile storage units 216 at the robotic picking station 202.

The MSU data 130 may include information about mobile storage units 216 and/or containers in the system, such as a unique identifier or license plate number for each mobile storage unit 216 or container, a mobile storage unit 216 or container type, the zones a mobile storage unit 216 will visit, the current or assigned location of a mobile storage unit 216, and the priority for the mobile storage unit 216. The MSU data 130 may include a list indicating the items, item types, and/or the quantity of items a mobile storage unit 216 (or a partition thereof) contains or should contain (e.g., it's maximum or assigned capacity). The MSU data 130 may include size or configuration of a mobile storage unit 216, associated automated-replenishment station 202, or other details.

The carton 218 data 132 may include various data pertaining to cartons 218 (e.g., shipping cartons 218 or cardboard boxes) in the system, such as a quantity and/or identity of cartons 218 in the system, on an input or queue for a robotic picking station 202, in a robotic picking station 202, on an output conveyor 222 of a robotic picking station 202 or otherwise. The carton 218 data may describe sizes, configurations, or other details of cartons 218. In some instances, the carton 218 data 132 may include an identifier or license plate number (LPN) of a carton 218. In some implementations, the carton 218 data may include associations between items and/or orders and license plate numbers of cartons 218. For example, as a carton 218 is received into a robotic picking station 202, its license plate number may be scanned and associated with the next order in a queue. Accordingly, the system may know which items a given carton 218 may or should contain.

The components of the system 100 may be coupled to exchange data via wireless and/or wired data connections. The connections may be made via direct data connections and/or a computer network. The computer network may comprise any number of networks and/or types of networks, such as wide area networks, local area networks, virtual private networks, cellular networks, close or micro proximity networks (e.g., Bluetooth, NFC, etc.), etc. In some implementations, one or more of these components may be coupled via a data communications bus.

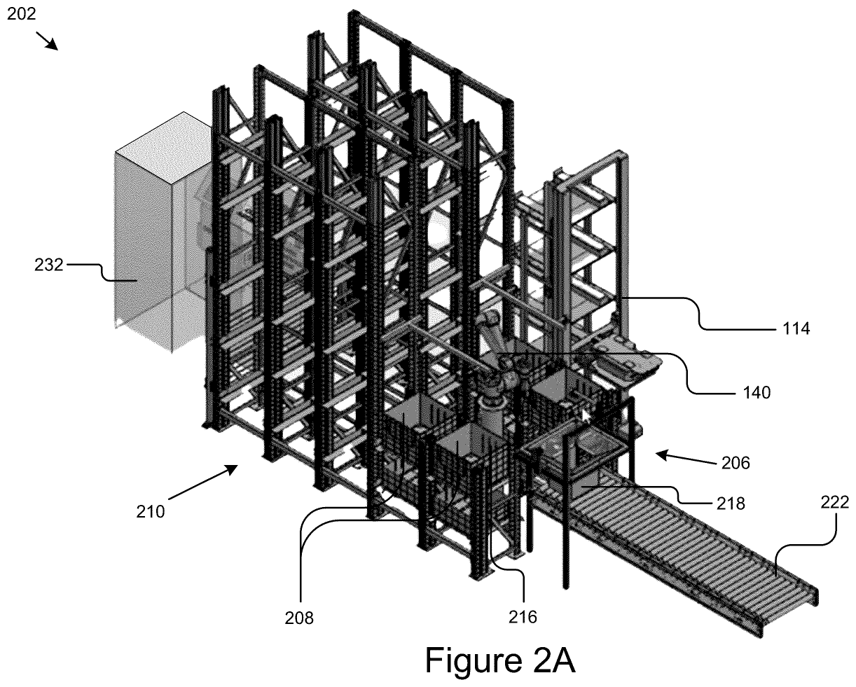

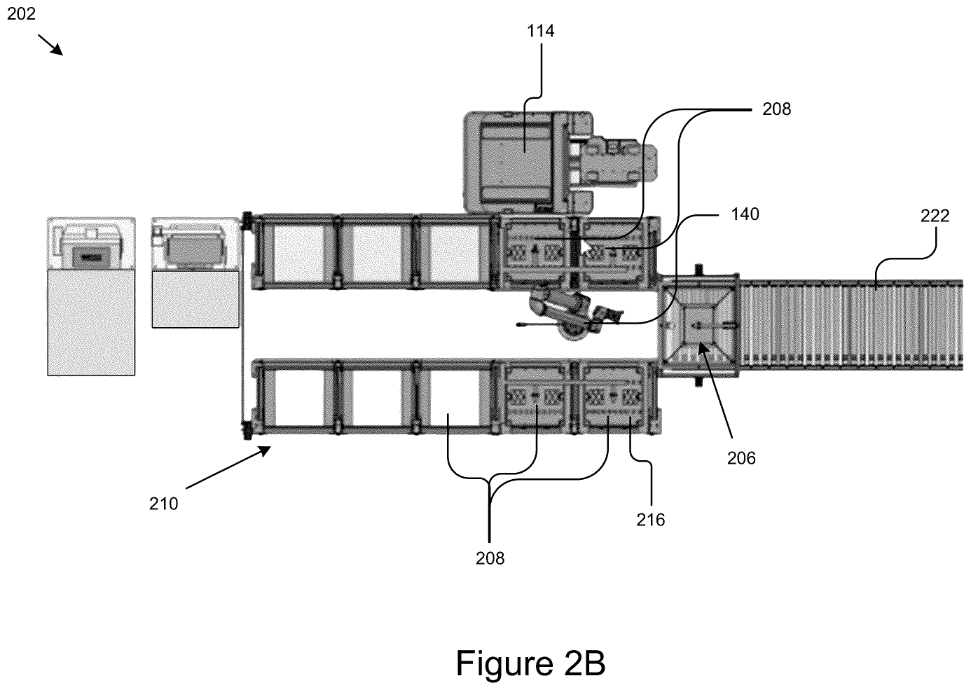

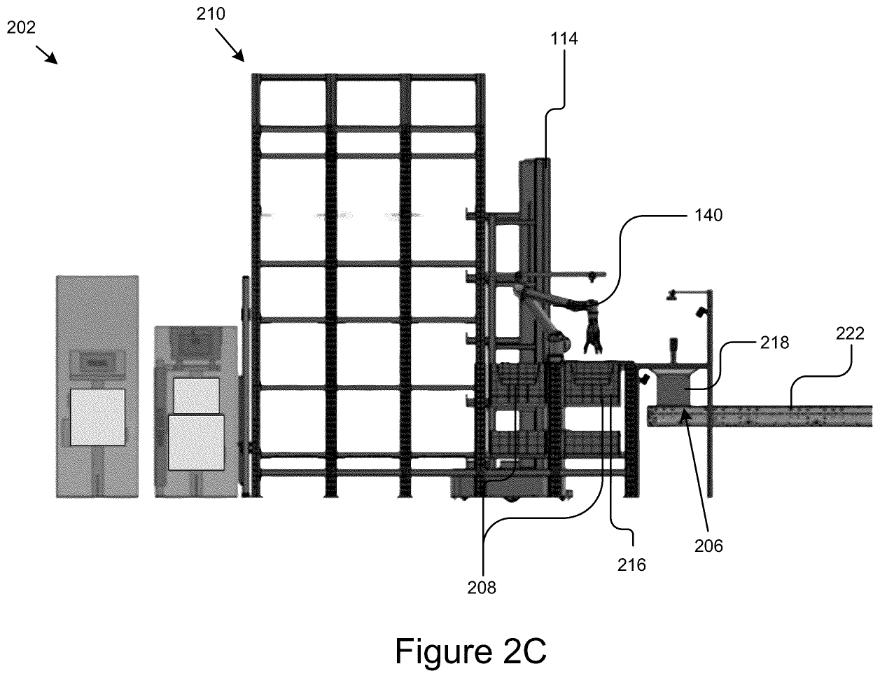

FIGS. 2A, 2B, and 2C illustrate example configurations of a robotic picking station 202 according to some implementations. The robotic arm picking station 202 may be part of a larger network of devices (e.g., conveyors 222, AGVs 114, other picking stations 202, etc.) in a fulfillment center, as described below. FIG. 2A illustrates a perspective view, FIG. 2B illustrates a top-down view, and FIG. 2C illustrates a side view of an example robotic picking station 202. It should be noted that the illustrated stations are provided by way of example and that other implementations, configurations, etc., are possible and contemplated herein.

The invention may include a system and method for picking items into shipping cartons 218, for example, using a robotic arm 140. According to some implementations of the technology, a line of unassigned cartons 218 may be conveyed to a robotic arm 140 robotic picking station 202 where orders, for example, with less than a determined quantity of different SKUs (e.g., items having different stock keeping unit identifiers) are picked into the carton 218. The robotic picking station 202 may include a vertical staging area 210 and items may be moved from the vertical staging area 210 to multiple bays around a robotic arm 140 by automated guided vehicles (“AGVs 114”), robots, or other devices to allow them to be more quickly picked into cartons 218.

In some implementations, the system may include a first conveyor 222 that transfers shipping cartons 218 from a carton erector to a robotic arm 140 robotic picking station 202 and from the robotic picking station 202 to finalization. The robotic picking station 202 may include a robotic arm 140, scanners, a carton receiving area 206, an active picking area where mobile storage units 216 may be stored, a staging area 210 for mobile storage units 216, and/or other features. The robotic picking station 202 may include multiple (e.g., four) picking slots for receiving totes, mini pallets, or other mobile storage units 216 containing items and from which items may be picked. The robotic picking station 202 may also include a staging area 210 for staging mobile storage units 216. In some instances, the staging area 210 may be proximate to the active picking slots but may have increased density (e.g., with shelves or slots organized vertically) than the picking slots. Automated guided vehicles (AGVs 114) or other devices or means may transfer totes between a storage area, staging area 210, and/or active picking slots.

Returning to the description of FIGS. 2A-2C, the example layout and components the robotic picking station 202 and associated elements may allow automated operations, as described in further detail below. Example features of the layout provide various benefits, for example, as described above. The WMS 104 may use multiple parallel processes and/or equipment to intelligently schedule, spit, and coordinate tasks.

It should be noted that the layout is merely provided as an illustrative example of how the technology described herein could be used and that other layouts, configurations, and uses may be used. Beneficially, the layout illustrated in the examples fits into a significantly smaller space than required for human picking while providing faster, more accurate picking than other automated picking methods.

The technology also includes a method for operating aspects of the robotic picking station 202, as described in further detail below. For instance, as described below, a line of un-assigned cartons 218 may be conveyed to a robotic picking station 202 where orders with less than a certain quantity of different SKUs are picked into the carton 218. The station 202 may include a vertical staging area 210 and items (e.g., in mobile storage units 216) may be moved from the vertical staging area 210 to multiple bays 208 around a robotic arm 140 by AGVs 114.

As illustrated, a robotic picking station 202 may include a robotic arm 140, a carton receiving area 206 that receives one or more cartons 218, one or more active picking bays 208 that receive one or more mobile storage units 216, a staging area 210 that holds mobile storage units 216 as a buffer, one or more sensors that scan cartons 218 (e.g., license plate numbers of cartons 218, which may be a barcode or QR code identifying an ID of a carton 218), one or more sensors that scan items (e.g., items picked from mobile storage units 216 by a robotic arm 140) to identify them as they are picked from a mobile storage unit 216 and/or placed in a carton 218, and other features. The components of a robotic picking station 202 may be controlled by one or more computing devices (e.g., in the cabinet 232) at the robotic picking station 202, which may be or be part of a component of the system 100, such as the WES 102, WMS 104, or equipment controller(s) 110.

In some implementations, as illustrated, the robotic arm 140 my have a range of motion that may be used to retrieve items from mobile storage units 216 and place them in a chute or carton 218. For instance, a carton receiving area 206, or a chute or area above it, may be within reach of the robotic arm 140. Similarly, the active picking bays 208 may be within reach of the robotic arm 140. Other storage, such as the staging area 210 may be outside reach of the robotic arm 140; however, other devices, such as AGVs 114 may be used to move mobile storage units 216 and/or items to the active picking bays 208.

In some implementations, a computing device may be present in or connected with the station 202 and may communicate with the WES 102, WMS 104, equipment controller 110, or other components of the system 100, as described elsewhere herein. For instance, a computing device located close to the robotic station 202 may perform image processing, communication, control, receive commands, or perform other operations, such as those described elsewhere herein. Depending on the implementation, the station's computing device may communicate via JSON (JavaScript Object Notation) over a TCP (Transmission Control Protocol) socket or another protocol with other components of the system 100 to perform the operations herein, for example.

In some implementations, the mobile storage units 216 may be placed by humans, AGVs 114, or other devices. For instance, an AGV 114 may bring a mobile storage unit 216 from a long-term storage area and place it on a shelf or bay at the staging area 210. The AGV 114 may pick a mobile storage unit 216 up from the staging area 210, transport it to a robotic picking station 202, and place it at an active bay 208 at the robotic picking station 202 (or move it back to a staging area 210). In some instances, the AGV 114 may retrieve the mobile storage unit 216 from the active bay or the staging area 210 and transport it back to long-term storage or another location in the fulfillment center.

Depending on the implementation, the system may include a first conveyor 222 that transfers shipping cartons 218 from a carton erector 304 (described below) to a robotic arm 140 robotic picking station 202 and from the robotic picking station 202 to finalization. The robotic arm 140 robotic picking station 202 may include a robotic arm 140 and scanners, active picking slots, a vertical staging area 210, etc., as described below.

Although a robotic arm 140 is described and illustrated in reference to the figures herein, other mechanisms for positioning items or other configurations of robotic arms 140 are possible, such as cranes, diverters, or other devices. A robotic arm 140 may be adapted to pick up or otherwise move one or more items and place the one or more items at a scanning location (e.g., the scanning location may be directly above a carton receiving area 206, although other locations are possible), above a chute, and/or into a carton 218 in a carton receiving area 206 of the robotic picking station 202. For instance, a robotic arm 140 (an example of which is the robotic arm 140) may include a suction and/or grasping mechanism that grasps items. For instance, the robotic arm 140 may include both a grasping claw and a suction mechanism.

The robotic arm 140 and/or sensor(s) may be controlled by an equipment controller 110 or may have its own computing unit that receives instructions (e.g., from the WES 102, WMS 104, or equipment controller 110) instructing the robotic arm 140 to perform certain tasks (e.g., move an item(s) from a defined location), in response, determines the specific movements or operations for the robotic arm 140, camera, or other components of the station. The station 202 or layout may include sensors, scanners, or other inputs that communicate with the computing unit or another component of the system 100, for instance, as described herein.

A robotic arm 140 may be positioned adjacent to the station to position an item above a chute where the item may be scanned, and the arm may drop it through the chute into a carton 218. The robotic arm 140 may be an off the shelf or dedicated robotic arm 140 or other device that can automatedly articulate to move items in response to instructions or signals from a computing device. For instance, the robotic arm 140 may include an off the shelf industrial arm (such as provided by RightHand Robotics™, Vention™, or Universal Robots™) mounted to a chassis with a gripper or suction cup for grasping items. In some implementations, the robotic arm 140 may include vision and machine learning software, smart grippers that provide feedback on grasp success and ensure pick accuracy.

The active picking bays 208 may include one or more bays, ledges, tables, shelves, or other locations within reach of the robotic arm 140 for receiving and holding items, such as items in mobile storage units 216 or totes. For example, four bays—two on each side—may be located around the robotic arm 140, although other implementations are possible. An AGV 114 or other device may place a tote at a picking bay 208. The WES 102 or other component of the system may store the location and identity of the mobile storage unit 216, so that it knows which items are at a given bay. Accordingly, as noted below, the WES 102 may know from which storage unit/bay to pick a certain item in an order, so it may direct the robotic arm 140 to remove the item from the storage unit/bay and place it in the carton 218.

The robotic picking station 202 may include a carton receiving area 206 at which a carton 218 (e.g., a shipping carton 218, although other containers are possible) may be held. For instance, the carton receiving area 206 may include a flat surface, such as the end of a conveyor 222 at which a carton 218 may be held. For example, as noted below, a conveyor 222 may convey a carton 218 to the carton receiving area 206, as illustrated, although other implementations are possible, such as where an AGV 114 or other means transports the carton 218 to/from the carton receiving area 206.

The carton receiving area 206 may be located within reach of the robotic arm 140, so that it can place items therein, for example, the carton receiving area 206 may be located along a side perpendicular to the active picking bays 208, as illustrated in the example. In some implementations, the carton receiving area 206 may have various configurations, such as a flat surface on which a shipping container rests, a cart onto which items are picked, a conveyor belt 222, a chute, a tote/mobile storage unit 216, or other configuration. For example, a carton 218 may be transported to and/or from the carton receiving area 206 on a conveyor 222.

As illustrated in the example, the carton receiving area 206 may have sloped sides and an aperture forming a chute through which items may pass. The item(s), passing through the chute may enter a shipping carton 218 or other container, for example, held on a conveyor 222. For example, once an item is identified as being a particular item and/or a single copy of the item, it may be dropped by the robotic arm 140 into the chute and/or carton 218. It should be noted that the system herein may be used in many different contexts in addition or alternative to the example illustrated.

In some implementations, the layout may include a scanning apparatus that holds one or more cameras at a defined position relative to robotic arm 140, such as above a chute and carton receiving area 206. The scanning apparatus may include one or multiple scanners that identify visual aspects, barcodes, shapes, sizes, or other aspects of items to confirm their identity before they are dropped into a carton 218 at the carton receiving area 206.

In some implementations, a scanner may additionally or alternatively be located near the carton receiving area 206 or an entrance thereto in order to identify the carton 218. As described below, a carton 218 may include a license plate number, barcode, or other identifier that identifies a carton 218. For instance, the WES 102 may scan a license plate number of a carton 218 and associate it with a next pick/order picked into the carton 218.

In some implementations, a single conveyor 222 may bring items into a carton receiving area 206 of a robotic picking station 202 and may be connected to one or more other conveyors 222. For instance, as described below, the robotic picking station 202's conveyor 222 may be located along one or more other conveyors 222, which may bring cartons 218 to and/or from the robotic picking station 202's conveyor 222. In some instances, multiple robotic picking stations 202 or other devices (e.g., carton erectors, finalization stations, label applicators, other robotic picking stations 202, etc.) may be located along these conveyors 222 to form a multi-step picking process.

In some implementations, a staging area 210 may be located adjacent to the active picking bays 208 so that mobile storage units 216 may be transferred between the staging area 210 and the active picking bays 208, which allows the staging area 210 to provide a buffer to the robotic picking station 202. For example, as described below, an AGV 114 may bring one or more mobile storage units 216 from a storage area of a fulfillment center and place them at the staging area 210. Accordingly, the AGV(s) 114 may quickly bring mobile storage units 216 from the staging area 210 to the active picking bays 208 as needed to fulfill orders in a task list. The WES 102, REX 118, or other component may proactively instruct AGVs 114 to bring items (e.g., in mobile storage units 216 or totes) to the staging area 210 and/or picking bays 208 so that they are ready for upcoming tasks.

As illustrated, a staging area 210 may include a plurality of shelves at which mobile storage units 216 containing items may be placed. In some implementations, the shelves may be vertically oriented and include ledges that hold edges of mobile storage units 216 or totes, so that a handling mechanism (e.g., a support surface or fork of an AGV 114) may more easily place mobile storage units 216 thereon or receive mobile storage units 216 therefrom.

As described in further detail above, one or more AGVs 114 in a fulfillment center may move mobile storage units 216 to/from various areas of the robotic picking station 202, although other implementations are possible and contemplated. An AGV 114 may include a power source, communication unit, processor, drive unit, guidance unit, item/tote handling mechanism, transportation shelves, and other features, as illustrated.

Other devices may also be present in, near, or associated with the station 202. For instance, the station 202 may have a computing device controlling its operations (e.g., an equipment controller 110 or other computer), receiving data from the cameras, etc. The station 202 may also include various off the shelf items, such as cameras (e.g., an Intel RealSense™ camera, etc.), power distribution units, CPUs, safety control units, emergency stop buttons, human-machine interface devices, pneumatic panels, enclosures, or other mechanisms.

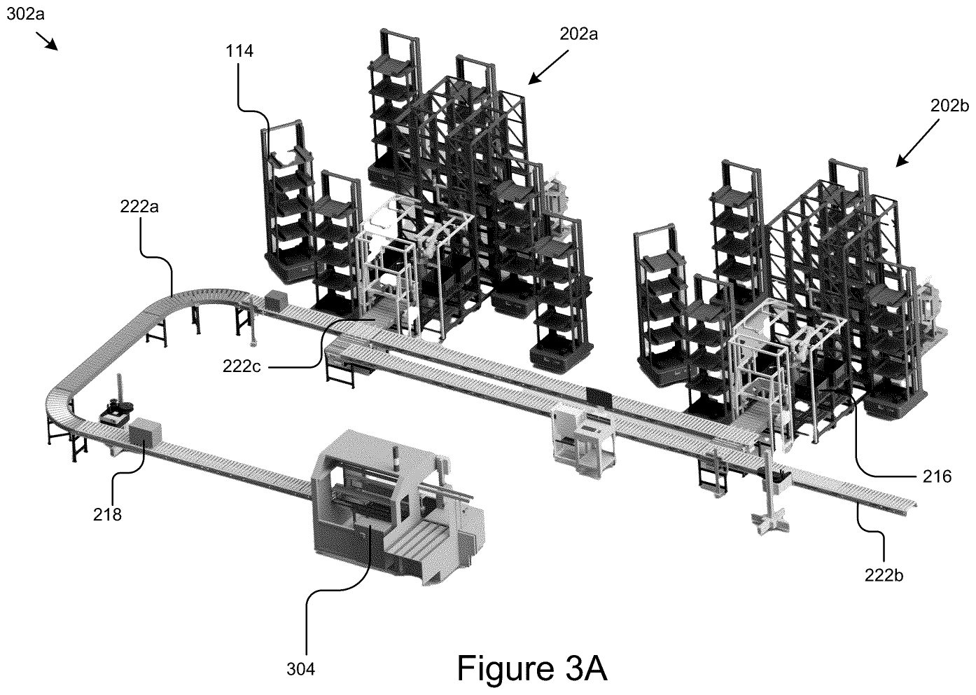

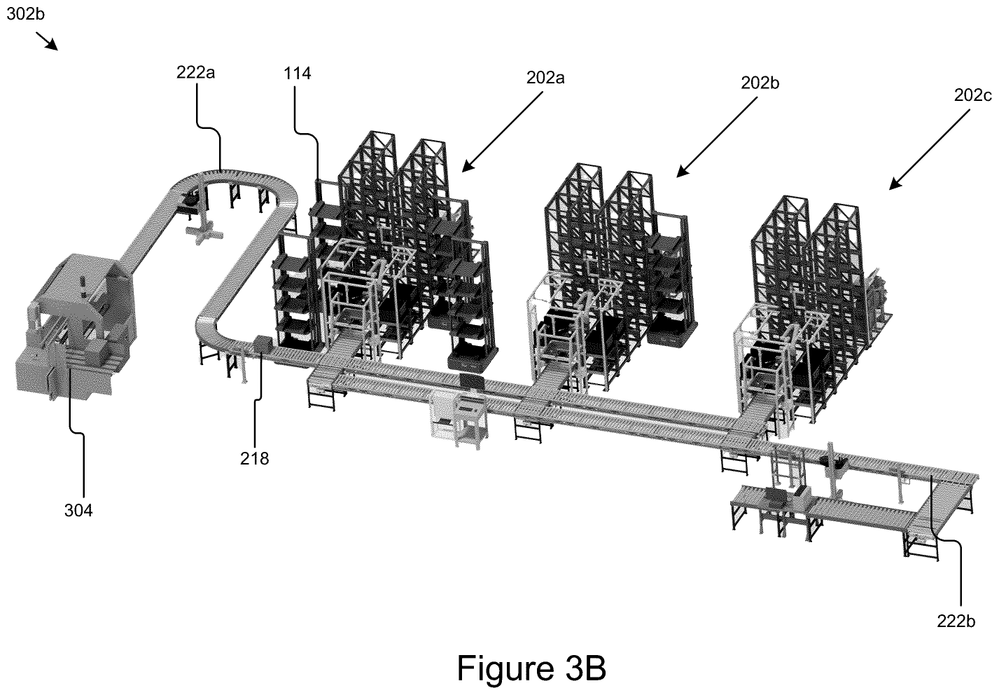

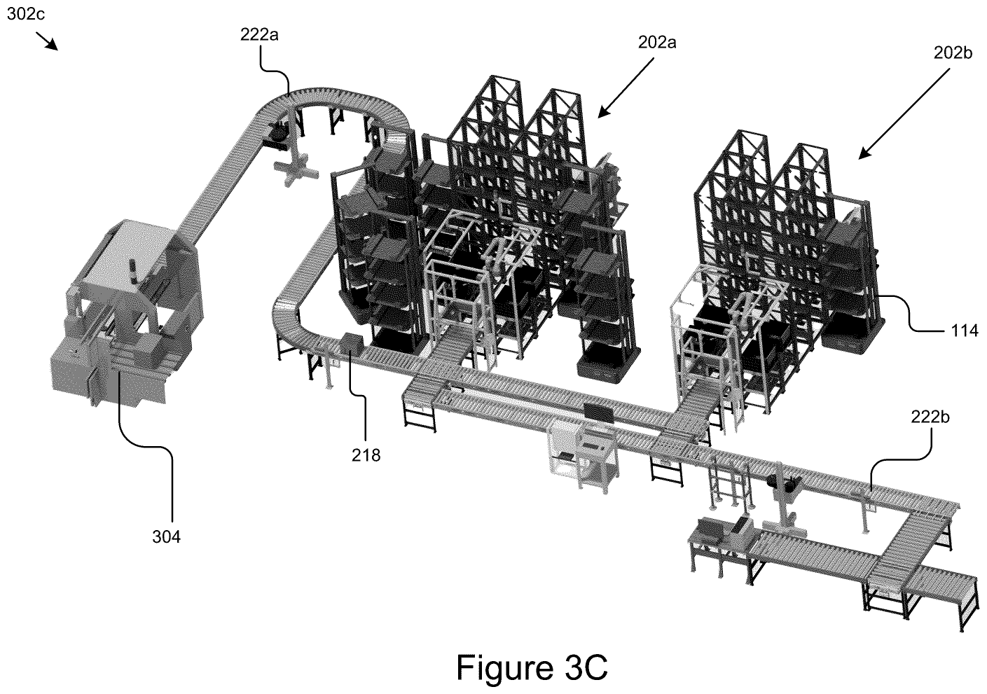

FIGS. 3A, 3B, and 3C illustrate various layouts of a picking system 302a, 302b, and 302c, respectively, for example, where one or more robotic picking stations 202 are used. For instance, the example picking systems illustrated in FIGS. 3A, 3B, and 3C may use the robotic picking station(s) 202 in a fulfillment center. The components of the system(s) 302a, 302b, or 302c may have various configurations, components, shapes, or other features.

FIG. 3A illustrates a perspective view of a first example layout of a picking system 302a in which two picking stations 202a and 202b are used. In the example layout in FIG. 3A, a first conveyor 222a extends from a box erector 304, past various components (e.g., a scanner, a label applicator, etc.) around multiple angles and ultimately past two illustrated robotic picking stations 202a and 202b. A second conveyor 222b is also shown extending past the picking stations 202a and 202b and partially along the first conveyor 222a.

FIG. 3B illustrates a perspective view of a second example layout of a picking system 302b in which three picking stations 202a, 202b, and 202c are used. Similar to FIG. 3A, in the example layout of FIG. 3B, a first conveyor 222a extends from a box erector 304, past various components (e.g., a scanner, a label applicator, etc.) around multiple angles and ultimately past three illustrated robotic picking stations 202a, 202b, and 202c. A second conveyor 222b is also shown extending past the picking stations 202a, 202b, and 202c and partially along the first conveyor 222a. The angles used in the conveyors 222a and 222b are different in FIG. 3B than in FIG. 3A.

FIG. 3C illustrates a perspective view of a third example layout of a picking system 302c in which two picking stations 202a and 202b are used. Similar to FIGS. 3A and 3B, in the example layout of FIG. 3C, a first conveyor 222a extends from a box erector 304, past various components (e.g., a scanner, a label applicator, etc.) around multiple angles and ultimately past two illustrated robotic picking stations 202a and 202b. A second conveyor 222b is also shown extending past the picking stations 202a and 202b and partially along the first conveyor 222a. The angles used in the conveyors 222a and 222b are different in FIG. 3C than in FIG. 3A and FIG. 3B.

As illustrated in the example layouts of FIGS. 3A, 3B, and 3C, a box erector 304 may be located at a point along a first conveyor 222a, respectively, and may erect boxes and place them on the first conveyor 222a. Accordingly, a queue of cartons 218 may form along the first conveyor 222a to feed the one or more robotic picking stations 202 also located along the first conveyor 222a.

In some implementations, a second conveyor 222b may also pass the one or more robotic picking stations 202. For example, a first conveyor 222a may bring empty cartons 218 to a robotic picking station 202 and a second conveyor 222b may bring cartons 218 holding item(s) away from a robotic picking station 202.

It should be noted that, in some implementations, a carton 218 may visit one, multiple, or zero of the robotic picking stations 202. For instance, an empty carton 218 may be transported on a first conveyor 222a to a first robotic picking station 202a (e.g., using the single in/out conveyor 222c at the carton receiving area 206 of the first robotic picking station 202a) where items are picked into the carton 218. The carton 218 may then be transferred out of the first robotic picking station 202a to the second conveyor 222b, which carries the carton 218 down the line to finalizing where it may receive labels, etc., as noted elsewhere herein. In some implementations, the carton 218 may be transferred from the second conveyor 222b into a second robotic picking station 202b at which it may receive additional items. For example, the carton 218, using its license plate number, may be identified and diverted into the second station 202b.

It should be noted that various types of conveyors 222 may be used, such as those that are straight, move around arcs, or pass through right angles. For example, in front of robotic picking stations 202, portions of the conveyor(s) 222 may allow items to move in multiple directions, such as past a robotic picking station 202, into the robotic picking station 202, past another conveyor 222 (e.g., 222a, 222b, or 222c), and/or onto a second conveyor 222.

As a line of cartons 218 move along a first conveyor 222a, a certain carton 218 may be transferred perpendicularly off the first conveyor 222a and into a first robotic picking station 202a and one or more of the line of cartons 218 may continue along the first conveyor 222a to a second robotic picking station 202b. When the pick(s) for the carton 218 (e.g., transported by the first conveyor 222) are completed, the line of cartons 218 on the first conveyor 222a may be stopped, the completed carton 218 may be transferred past the first conveyor 222a and onto the second conveyor 222b (e.g., by an in/out conveyor 222c). In some instances, the flow of cartons 218 on the second conveyor 222b may be stopped or timed to allow the carton 218 to fit onto an empty space thereon.

In some implementations, cartons 218 are transported downstream on the second conveyor 222b to one or more other devices. For instance, a license plate number of a carton 218 may be scanned downstream in processing allowing it to be identified and other operations to be performed. For example, a label applicator and/or printer may be located downstream and, based on the identification of the carton 218 and an associated order, a label may be automatically printed and/or applied. In some implementations, the carton 218 may be diverted to a different type of picking station to receive additional picks, to a finalization station to be closed and/or placed on a delivery vehicle, or otherwise processed.

In some instances, the system may identify a picking error based on a missing item, an incorrect item being scanned, or otherwise and the license plate number may be flagged for manual correction by a human downstream. In some instances the corrective action may include replacing the carton 218 on the first conveyor 222a and restarting picking of that order. Accordingly, where a license plate number is used until a carton 218 is completed, the carton 218 may be re-assigned without having to re-print a shipping label or trash the carton 218.

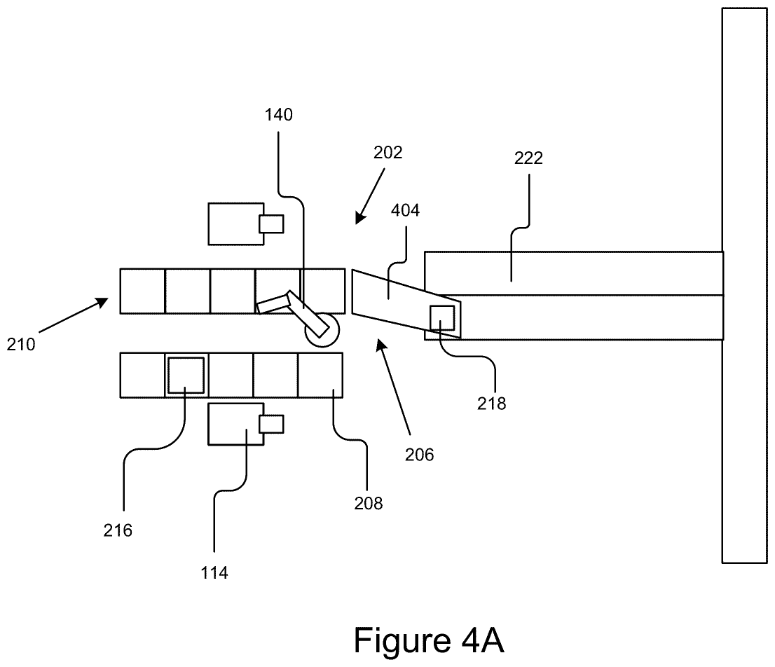

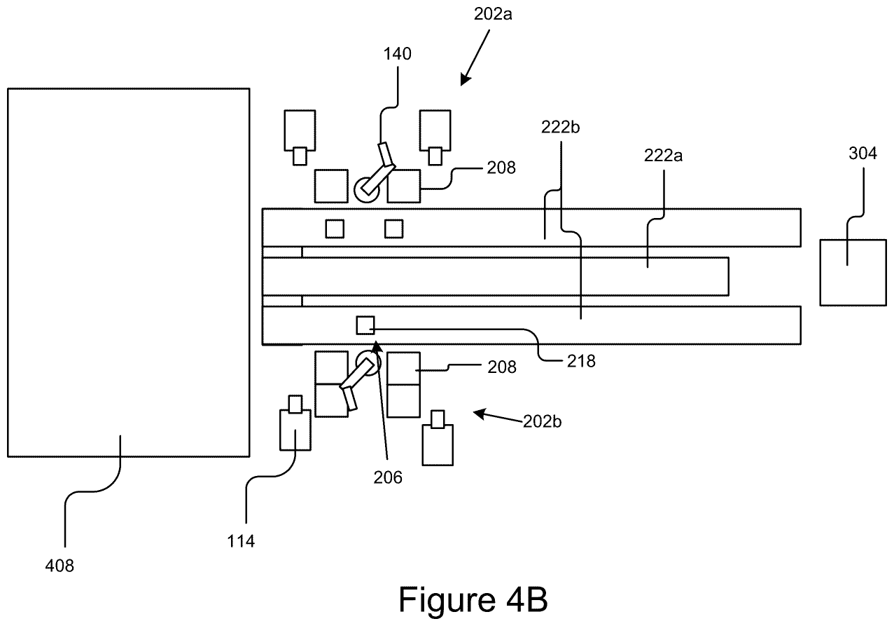

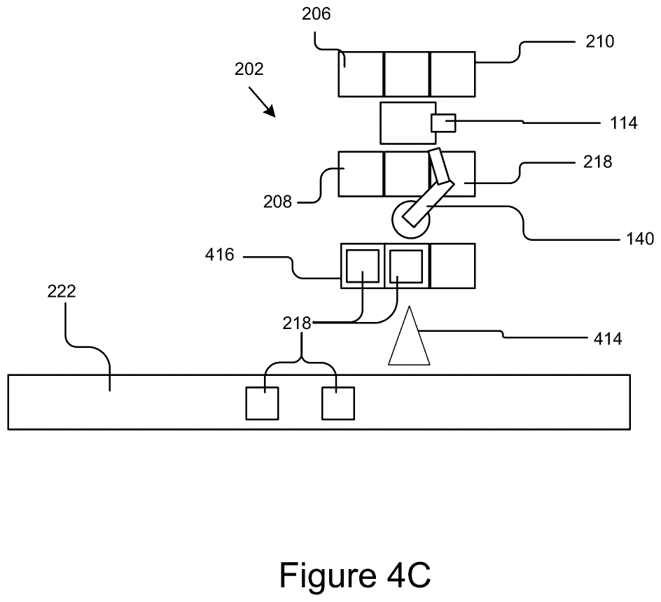

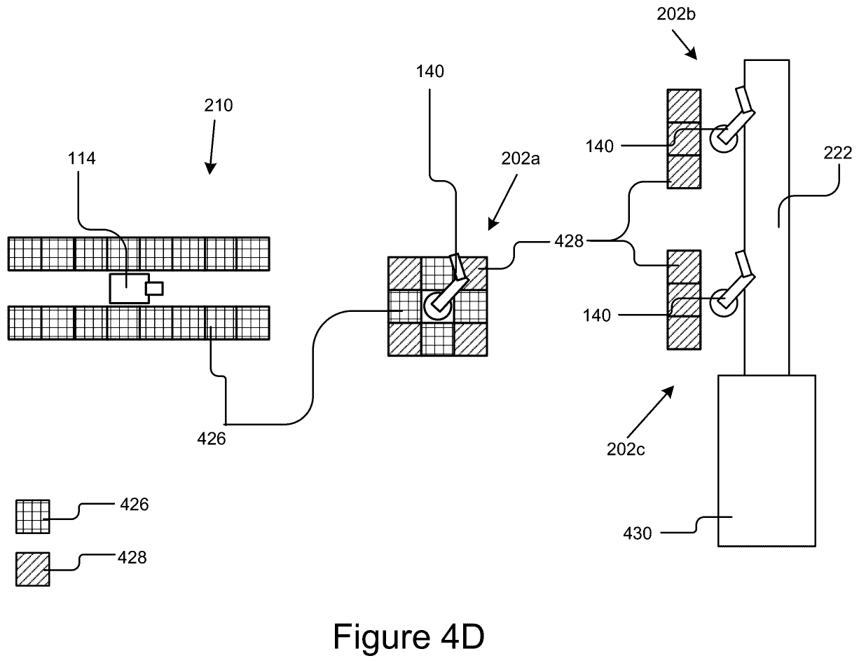

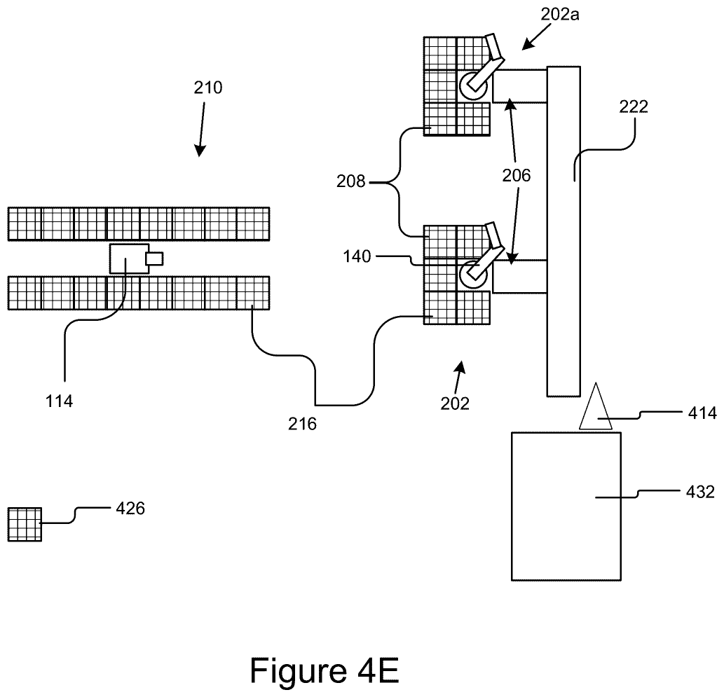

FIGS. 4A-4E illustrate various configurations of robotic picking stations 202 and fulfillment center layouts according to some implementations of the technology described herein. These and other example layouts may be used. For instance, some aspects of the examples of FIGS. 4A-4E may be used in combination or in alternative to those described above and elsewhere herein.

As illustrated in FIG. 4A a chute 404 at a robotic picking station 202 may extend between a location at the robotic picking station 202 and a location of a carton 218 on one or more conveyors 222. In the illustrated example, multiple conveyors 222 may be used, for example, where a first conveyor 222 moves a carton 218 to a robotic picking station 202 and a second conveyor 222 moves a carton 218 away from the robotic picking station 202. For instance, items may be picked from bays 208 (e.g., in mobile storage units 216) by a robotic arm 140 and into the carton 218 at the first conveyor 222 and the carton 218 is then diverted or moved onto a second conveyor 222 where it is transferred away from the robotic picking station 202 to make room for a second carton 218. In some implementations, as shown in the example, the robotic arm 140 may drop the item onto a chute 404, which may allow the item to slide into the carton 428. Multiple chutes may be used or the robotic arm 140 may otherwise pick items into multiple cartons 218. The conveyor(s) 222 may be in a loop to allow the cartons 218 to move through or there may be a diverter, arm, or other mechanism that moves the cartons 218 between the conveyors, so that they can move to/from the picking station 202. The example of FIG. 4A also allows an opening at the robotic arm 140 (e.g., adjacent to a chute 404) to allow maintenance, etc., of the robotic arm 140.

FIG. 4B illustrates another example in which one or more robotic picking stations 202a and 202b are located adjacent to a long-term storage area 408, which may omit a staging area 210 while still allowing mobile storage units 216 to be quickly moved to robotic picking stations 202. Similarly, in some implementations, the robotic picking station(s) 202 may be located directly along a conveyor 222 to pick items into carton(s) 218 on the conveyor 222, for example, as illustrated in the example.

As shown in the example, a first conveyor 222a may transport new/unassigned cartons 218 to one or more second conveyors 222b may transport the carton(s) 218 past the picking stations 202a and 202b. For instance, the carton receiving area(s) 206 may be located along the first or the second conveyors 206. This loop or direction may be changed in other implementations.

In the depicted example, one or more active picking bays 208 may be in the picking station(s) 202a and 202b. Additionally, the picking bays 208 may be adjacent to a storage area 408 (e.g., storing mobile storage units 216 on shelves), so that AGVs 114 or other devices may quickly transport the mobile storage units 208 and/or items between the storage area 408 and the active picking bay(s) 208.

FIG. 4C illustrates an example layout in which a conveyor 222 carries cartons 218, and a human agent 414 or other device moves the cartons 218 between the conveyor 222 and one or more carton receiving locations 416, which may serve as a carton receiving area 206 to which items may be picked by a robotic arm 140. If a human agent 414 is involved, the human interface system 108 may direct the agent 414 to move the cartons in coordination with the operations of the robotic arm 140 and/or AGV 114. Similarly, picking bays 208 may be loaded adjacent to the robotic arm 140 and an AGV 114, or other device, may move items (separately or in mobile storage units 216) between a staging area 210 or storage area and the active picking bays 208 adjacent to the picking arm. The staging area 210 may be loaded or maintained by the AGV 114 or another device (e.g., another AGV 114) from a storage area.

FIG. 4D illustrates an example layout in which an AGV 114 moves mobile storage units 426 between a staging area 210 and a robotic picking station 202 around a robotic arm 140. The robotic picking station 202 may include locations for mobile storage units 426 and/or cartons 218. For instance, the robotic arm 140 may consolidate items into fewer mobile storage units 426, which are then moved to a secondary robotic picking station 202b or 202c where robotic arms 140 move the items onto a conveyor 222, which may move into a sorting device.

As illustrated in the example of FIG. 4D, mobile storage units 216, which may correspond to 216 (e.g., totes, mini-pallets, etc.) described elsewhere herein, may hold one or more SKUs and may be moved between a storage area (not shown) and a staging area 210, and between a staging area 210 and a picking station 202a. Similarly, mobile storage unit(s) 428 may receive picks and/or may hold carton(s) 218 that may receive picks.

The example picking station 202a illustrated in FIG. 4D may include locations surrounding it that each receive a mobile storage unit 426 or 428. The WES 102 or other system may track which locations include are supplying items and which locations are receiving items. Although other implementations are possible, one or more AGVs 114 may transport mobile storage units 426 between a staging area 210, a picking station 202a, and a storage area, as needed. Similarly, one or more AGVs 114 may transport mobile storage units 428 needing picks (whether empty or already containing items) to a picking station 202. The mobile storage units 428 may loaded at a carton erector, conveyor, or other location and then transported by an AGV 114 or other device to the picking station 202a.

After the mobile storage units 428 have received picks at a picking station 202a, an AGV 114 (or other device) may move the mobile storage units 428 to secondary picking station 202b or 202c, which may include one or more locations for holding the mobile storage units 428. The robotic arm(s) 140 (or human agents, other devices, etc.) at the secondary picking station(s) 202a or 202b may move items from the mobile storage units 428 onto a conveyor 222. In some implementations, the robotic arms 140 or otherwise may move cartons 218 from inside the mobile storage units 428 onto the conveyor 222. In other implementations, the conveyor 222 may hold cartons 218 transported past the secondary picking stations 202b and 202c, which cartons 218 receive picks/items. Depending on the implementation, the conveyor 222 may include other systems 430, such as a box erector, finalizing station, or otherwise.

FIG. 4E illustrates an example layout in which an AGV 114 moves mobile storage units 428 from a storage area or staging area 210 to picking bays 208 at one or more robotic picking stations 202. For example, the layout may be similar to that described in reference to FIG. 3A, but the robotic arm 140 may pick items directly onto one or more conveyors 222. In some implementations, the conveyors 222 may carry the item(s) to a unit sorter 432 (directly and/or via a picker 414) that sorts the items into one or more cartons 218.

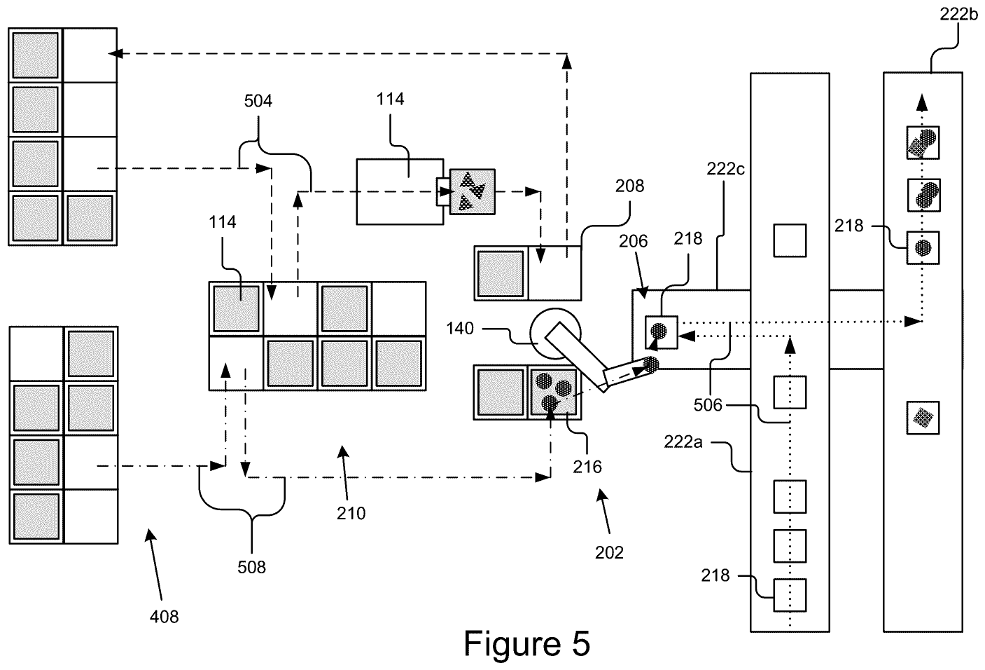

FIG. 5 illustrates an example layout of a facility in which one or more robotic arm picking stations 202 are used, which may be similar to those described elsewhere herein. FIG. 5 also illustrates example paths 504, 506, and 508, as described below, which depict example steps of the objects as they are processed, as described in detail throughout this disclosure. It should be noted that although multiple cartons 218, mobile storage units 216, etc., are illustrated in FIG. 5, not all of them have been labeled.

In some implementations, a carton 218 may be constructed in a carton erector along a first conveyor 222a, which may, for instance, press the sides of a carton 218 into place and apply or scan a license plate number, etc. The carton erector may place cartons 218 directly onto the first conveyor 222a to move to robotic picking stations 202. Various configurations of carton erectors may be used, or cartons 218 may be manually constructed and placed onto the conveyor 222a. In other implementations, cartons 218 may be placed directly into a robotic picking station 202.

The example path 506 illustrates a line of carton 218 along the first conveyor 222a, which may move the cartons 218 to or past a robotic picking station 202. As shown, a carton 218 may be diverted horizontally from the first conveyor 222a and into a robotic picking station 202. For instance, a device, portion of the first conveyor 222a, or a conveyor 222c may be capable of moving the carton 218 in two directions, so that it can be moved into the robotic picking station 202.

For example, a conveyor 222c may move a carton 218 into a robotic picking station 202 to a space below a chute (not shown in FIG. 5) at the carton receiving area 206. A scanner may point toward a face of the carton 218 on which a license plate number or other identifier is located to identify the carton 218. Based on the carton 218 identification, a next order to be picked at the robotic picking station 202 may be associated with the carton 218 identification, such as based on a task list and/or the items/mobile storage units 216 at the active picking bays 208 and/or staging area 210.

FIG. 5 shows a carton 218, which may be located directly below a chute (e.g., at 206) of the robotic picking station 202. In some instances, the height of the chute may be configured to match the vertical edges of the carton 218. In some instances, the size of the aperture in the chute may match the size of the carton 218, accordingly, odds of a picked item landing outside of the carton 218 may be reduced.

A robotic arm 140 may reach into a mobile storage unit 216 in a given active picking bay 208 of the robotic picking station 202. The system (e.g., the equipment controller(s), WES 102, etc.) may direct the robotic arm 140 to pick an item from a certain bay based on the presence of the carton 218, the presence of a defined mobile storage unit 216, a task list, and/or another trigger.

The robotic arm 140 may be articulated to hold an item above a chute where it may be scanned. In some instances, the item may be held solely by a suction cup while the claws of the arm lift in order to allow a clearer image by one or more scanners located adjacent to the chute. For example, the scanners may scan the item, and transmit the identification (e.g., a SKU) to the WES 102, which confirms that it matches the identity of an item that was supposed to be picked from the corresponding mobile storage unit 216 at the active picking bay 208 from which it was retrieved.

Once the identity of the item has been confirmed, the robotic arm 140 may be instructed to drop the item into the chute and/or carton 218 in the carton receiving area 206. In some implementations, the robotic arm 140 may wait for an instruction based on a confirmed identity of the item before dropping the item. For instance, if the item is duplicated or incorrect, the WES 102 may direct the robotic arm 140 to place it back into the mobile storage unit 216, reattempt the pick, and/or wait for human intervention. In some implementations, the robotic arm 140 may automatically drop an item regardless of its identity and, when the item is identified (even after the pick is complete or the carton 218 has left the robotic picking station 202), the WES 102 may flag the carton 218 (e.g., an identifier thereof) for manual correction or quality assurance downstream.

In some implementations, multiple items may be picked from a single mobile storage unit 216 (whether of the same or different SKUs) or items may be picked from different mobile storage units 216 in the active picking bays 208. Additionally, where the order being fulfilled into the carton 218 includes items not in an active picking bay 208, the WES 102 may instruct an AGV 114 or other device to move the mobile storage unit(s) 216 containing the additional item(s) to the active picking bays 208, from which the robotic arm 140 may pick the items into the carton 218.

Continuing along the path 506, Once the picks for the carton 218 are complete, the conveyor 222c may divert the carton 218 from the carton receiving area 206 and away from the robotic picking station 202. For instance, the line of cartons 218 on the first conveyor 222a may be stopped to allow the completed carton 218 to be transferred onto the first conveyor 222a or past the first conveyor 222a and to a second conveyor 222b. For instance, a single conveyor 222 may be used to carry cartons 218 to and from a robotic picking station 202 (e.g., where picked or empty/fresh cartons 218 are identified based on scans of their license plate numbers), or separate conveyors 222 may be used for delivery to and extraction from a robotic picking station 202.

The completed carton(s) 218 may be transported perpendicularly past the first conveyor 222a (e.g., delivering fresh cartons 218) and onto a second conveyor 222b that transfers the carton 218 downstream for further operations (e.g., label application, shipping, a pick at another picking station 202, etc.). In some implementations, the carton 218, after receiving a pick, may be transported on the first conveyor 222a or second conveyor 222b to another picking station 202 to receive another pick/item.

As illustrated in FIG. 5, an example path 504 of a mobile storage unit 216 is also illustrated. For example, an AGV 114 may retrieve the mobile storage unit 216 from a storage area 408 and transport it to a staging area 210. Once the items in the mobile storage unit 216 are needed, an AGV 114 may transport the mobile storage unit 216 to an active picking bay 208 at the picking station 202. The location of the mobile storage unit 216 (and therefore the items in it) may be tracked by tracking completion of tasks of moving it and/or by scanning an identifier attached to it at one or more steps. Once the picks/assigned tasks/lines for the mobile storage unit 216 have been completed, it may be transported back to the staging area 210, a staging area 210 of another picking station, or to a high-density storage area 408 (whether directly or via a staging area 210). For example, each of these moves may be automatically performed by one or more AGVs 114.

FIG. 5 also illustrates another example path 508 of an item. The item may be transported from a storage area 408 to a staging area 210, for example, inside a mobile storage unit 216. The item may be transported to an active picking bay 208 inside the mobile storage unit 216. The robotic arm 140 may grasp the item from mobile storage unit 216 and articulate to a scanning location where the identity of the item may be determined or confirmed. The robotic arm 140 may then place the item (e.g., by dropping it through a chute) into a carton 218, which may be transported by a conveyor 222c or other means to a conveyor 222b, which may transport the item in the carton 218 to a downstream processing location. For instance, another scanner along the conveyor 222b may scan the license plate number/code on the carton 218, identify an order associated with the license plate number, and cause a packing slip and/or shipping label to be printed. These may be automatically inserted into and/or applied to the carton 218 or other processing may be performed, as noted elsewhere herein.

Accordingly, these configurations, features, and components may perform operations that allow nearly or fully automated movement and picking of mobile storage units 216, items, and/or cartons 218 in an efficient, coordinated, robust, compact, and/or buffered manner.

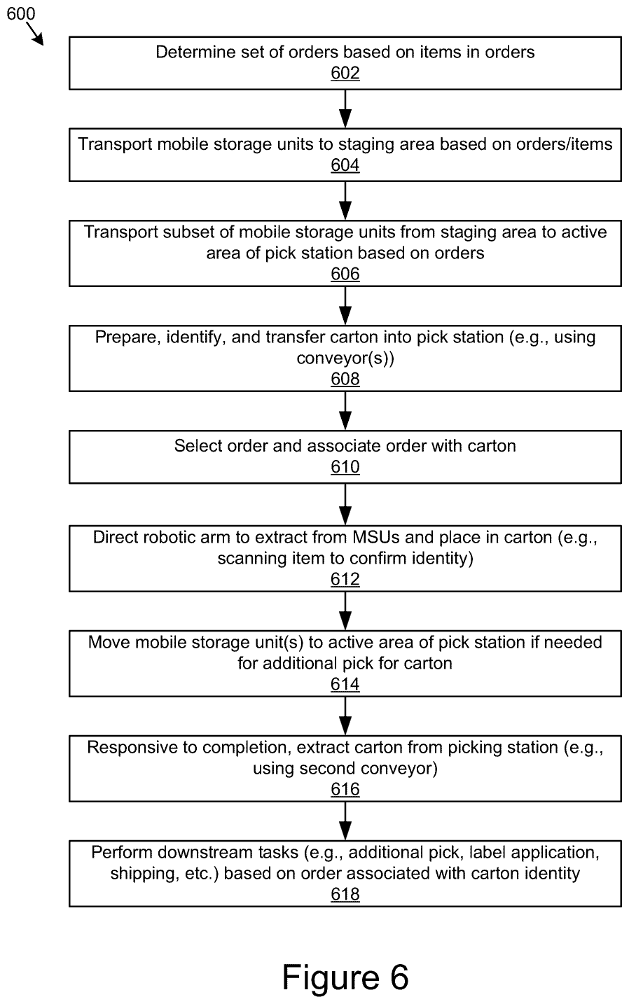

FIG. 6 is a flowchart of an example method 600 for picking items, for example using the systems, operations, features, and technologies described herein. The operations described in reference to FIG. 6 may be used with components and features described throughout this description. It should be noted that the operations of the method 600 may be used interchangeably or with the other operations and features used herein. Furthermore, it should be noted that operations of the method 600 and of this description may be augmented, reordered, omitted, or modified while still using technologies described in this disclosure. It should be noted that although the operations of the method 600 are described as being performed by the system, codes and routines, etc. (e.g., executed on a WES 102 or equipment controller), other implementations are possible. For instance, they may be performed on or by other devices, such as those of the system 100.

In some implementations, at 602, the system may determine a set of orders based on items in the orders. For instance, the system may determine orders with single picks, orders with multiple picks of single items, orders with the same items, or similar. The system may determine to fulfill orders with common items sequentially. Similarly, the system may determine to fulfill orders with minimal changes sequentially, so that the frequency of movement of mobile storage units 216 (e.g., between storage, staging, and active picking locations) is reduced. Orders for fulfillment may be grouped for a period of time (e.g., hourly, daily, a defined picking session, defined quantity of orders, defined quantity of picked items, etc.).

Accordingly, the system may generate a task list of a set or sequence of orders to be picked, along with items to be picked/the mobile storage units 216 from which the items are picked.

In some implementations, at 604, the system may transport one or more mobile storage units 216 to a staging area 210 of a robotic picking station 202 (e.g., from a storage area of a fulfillment center) based on the orders and/or items in the orders. For instance, using the task list or set of orders to be picked, the REX server 118 may direct one or more AGVs 114 to retrieve mobile storage units 216 from storage and place them at one or more of the staging area 210 and active picking bays 208 (e.g., those units to be used first may be placed at the picking bays 208 first). For example, using the selected series of orders, 30-40 mobile storage units 216 may be brought over at once for a picking session.

In some implementations, at 606, the system may transport a subset of mobile storage units 216 from the staging area 210 (or a storage are of the fulfillment center) to active picking bay(s) 208 of the robotic picking station 202 based on the order(s) and/or item(s) in the orders. For instance, for a subsequent order or pick that uses an item at the staging area 210, the REX server 118 may direct an AGV 114 to transport a corresponding mobile storage unit 216 from the staging area 210 to the active picking bay 208. For instance, prior to a next order that needs a next mobile storage unit 216, based on the task list, the REX server 118 may direct a nearby, available, or dedicated AGV 114 to transport the mobile storage unit 216 to the active picking bay 208.

In some implementations, at 608, the system may prepare, identify, and/or transfer a carton 218 into the pick station (e.g., using conveyor(s) 222). For instance, a carton erector may construct a carton 218 and place it on a first conveyor 222 that transports the carton 218 to the robotic picking station 202, as described above. A pre-label or license plate number may be placed on the carton 218, or a pre-existing license plate number may be scanned as the carton 218 passes a point on the conveyor 222 or is received at a carton receiving area 206 of a robotic picking station 202.

In some implementations, at 610, the system may select an order from a task list, queue, or set of orders for a picking session, and the system may associate the order with a carton 218, such as with a license plate number of the carton received into a carton receiving area 206 of the robotic picking station 202. For example, a next order in a sequence or set of orders may be selected based on corresponding items in mobile storage units 216 in the active picking bays 208. If no order is available using solely those mobile storage units 216 at the active picking bays 208, an order may be selected that uses the fewest number of mobile storage units 216 retrieved from the staging area 210, fewest number of mobile storage units 216 received from a storage area, or otherwise (e.g., based on distance traveled or workload of AGVs 114).

In some implementations, at 612, the system may direct the robotic arm 140 to extract an item in the order from a corresponding mobile storage unit 216 in an active picking bay 208 and place the item in the carton 218. In some instances, as noted above, the system may direct the robotic arm 140 to hold the item, so that it can be scanned, and its identity confirmed prior to dropping it into the carton 218.

For example, the system (e.g., via the equipment controller 110) may instruct a robotic arm 140 to retrieve an item from a certain tote (e.g., where multiple totes or conveyance devices are at the station), grasp the item with a robotic hand, articulate the item to/above the assigned chute, which may be a scanning area, and may hold the item at the location until its identity and/or quantity are determined. For instance, the WMS 104 may issue an instruction to move one or more items from a source location to a target location, and a computing device (e.g., an equipment controller 110) at the station may determine and execute operations by the robotic arm 140 to move the item(s).

In some implementations, at 614, the system may move one or more mobile storage units 216 to an active area of the pick station (e.g., from a staging area 210 and/or long-term storage area), for example, by instructing one or more AGVs 114 via the REX server. For instance, if items are needed from mobile storage units 216 not at the active picking bays 208 to complete a pick for the order being picked (e.g., assigned to a carton 218 at the station), the additional mobile storage unit(s) 216 holding the remaining item(s) may be moved to the picking bay(s) 208 and the remaining item(s) may be picked into the carton 218 by the robotic arm 140, as noted above. For example, active mobile storage units 216 may be shuffled between the staging area 210 and the active picking bay(s) 208 to allow orders with various sets of items to be fulfilled.

In some implementations, at 616, the system may, responsive to completion of picks for the carton 218 at the robotic picking station 202 or another trigger, extract the carton 218 from the robotic picking station 202 (e.g., using a second conveyor 222 or my reversing an in/out conveyor 222 to move it to a second conveyor 222). For instance, the WES 102 may direct the conveyor 222 at the carton receiving area 206 of the robotic picking station 202 to move the carton 218 away. As described above, the WES 102 and/or equipment controller(s) may control one or more conveyors 222 to coordinate the movement of the carton 218 across or to the conveyor(s) 222.

In some implementations, at 618, the system may perform other tasks downstream for the carton 218 based on an order associated with the carton 218/carton 218's license plate number. For example, the downstream tasks may include performing an additional pick into the carton 218 (e.g., by a human picker, by another robotic picking station 202, etc.).

In some implementations, as a carton 218 is transferred on a second conveyor 222 away from the robotic picking station 202, its license plate number may be scanned, and a shipping or other label may be applied to the carton 218. For example, an automated scanner and label applicator may be used, or a human picker may manually scan the license plate number to print the label and apply it, place packing materials in the carton 218, or perform other actions.

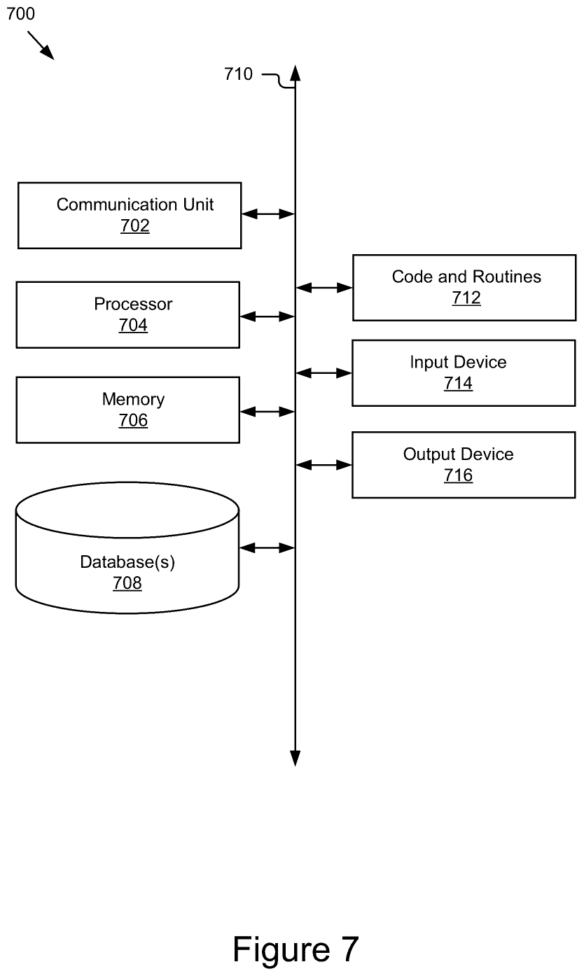

FIG. 7 is a block diagram illustrating an example computing system 700. The example computing system 700 may correspond to a WES 102, a WMS 104, a dispatch system 106, a human interface system 108, equipment controller(s) 110, REX server 118, a client device, a computing device of a robotic arm picking station 202, or other component of the system 100, for example.

The code and routines 712 may include computer logic executable by the processor 704 on a computing system 700 to provide for the functionality described in reference to one or more of the components of the system 100. For instance, in some implementations, the code and routines may include one or more of the components of the WES 102 or equipment controller(s) 110.

As depicted, the computing system 700 may include a processor 704, a memory 706, a communication unit 702, an output device 716, an input device 714, and database(s) 708, which may be communicatively coupled by a communication bus 710. The computing system 700 depicted in FIG. 7 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc. While not shown, the computing system 700 may include various operating systems, sensors, additional processors, and other physical configurations. Although, for purposes of clarity, FIG. 7 only shows a single processor 704, memory 706, communication unit 702, etc., it should be understood that the computing system 700 may include a plurality of one or more of these components.

The processor 704 may execute software instructions by performing various input, logical, and/or mathematical operations. The processor 704 may have various computing architectures to process data signals including, for example, a complex instruction set computer (CISC) architecture, a reduced instruction set computer (RISC) architecture, and/or an architecture implementing a combination of instruction sets. The processor 704 may be physical and/or virtual, and it may include a single core or plurality of processing units and/or cores. In some implementations, the processor 704 may be capable of generating and providing electronic display signals to a display device, supporting the display of images, capturing and transmitting images, performing complex tasks including various types of feature extraction and sampling, etc. In some implementations, the processor 704 may be coupled to the memory 706 via the bus 710 to access data and instructions therefrom and store data therein. The bus 710 may couple the processor 704 to the other components of the computing system 700 including, for example, the memory 706, the communication unit 702, the input device 714, the output device 716, and the database(s) 708.

The memory 706 may store and provide access to data to the other components of the computing system 700. The memory 706 may be included in a single computing device or a plurality of computing devices. In some implementations, the memory 706 may store instructions and/or data that may be executed by the processor 704. For example, the memory 706 may store the code and routines 712. The memory 706 is also capable of storing other instructions and data, including, for example, an operating system, hardware drivers, other software applications, databases, etc. The memory 706 may be coupled to the bus 710 for communication with the processor 704 and the other components of computing system 700.

The memory 706 may include a non-transitory computer-usable (e.g., readable, writeable, etc.) medium, which can be any non-transitory apparatus or device that can contain, store, communicate, propagate or transport instructions, data, computer programs, software, code, routines, etc., for processing by or in connection with the processor 704. In some implementations, the memory 706 may include one or more of volatile memory and non-volatile memory (e.g., RAM, ROM, hard disk, optical disk, etc.). It should be understood that the memory 706 may be a single device or may include multiple types of devices and configurations.

The bus 710 can include a communication bus for transferring data between components of a computing device or between computing devices, a network bus system including a network or portions thereof, a processor mesh, a combination thereof, etc. The software communication mechanism can include and/or facilitate, for example, inter-method communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

The communication unit 702 may include one or more interface devices (I/F) for wired and wireless connectivity among the components of the system 100. For instance, the communication unit 702 may include various types known connectivity and interface options. The communication unit 702 may be coupled to the other components of the computing system 700 via the bus 710. The communication unit 702 may be electronically communicatively coupled to a network (e.g., wiredly, wirelessly, etc.). In some implementations, the communication unit 702 can link the processor 704 to a network, which may in turn be coupled to other processing systems. The communication unit 702 can provide other connections to a network and to other entities of the system 100 using various standard communication protocols.

The input device 714 may include any device for inputting information into the computing system 700. In some implementations, the input device 714 may include one or more peripheral devices. For example, the input device 714 may include a keyboard, a pointing device, microphone, an image/video capture device (e.g., a 2D or 3D camera), a touchscreen display integrated with the output device 716, optical scanner, barcode reader, QR™ code reader, RFID (radio-frequency identification) tag reader, etc.

The output device 716 may be any device capable of outputting information from the computing system 700. The output device 716 may include one or more of a display (LCD, OLED, etc.), a printer, a 3D printer, a haptic device, audio reproduction device, touch-screen display, etc. In some implementations, the output device is a display which may display electronic images and data output by the computing system 700 for presentation to a user, such as a picker or associate in the order fulfillment center. In some implementations, the computing system 700 may include a graphics adapter (not shown) for rendering and outputting the images and data for presentation on output device 716. The graphics adapter (not shown) may be a separate processing device including a separate processor and memory (not shown) or may be integrated with the processor 704 and memory 706.

The database(s) are information source(s) for storing and providing access to data. The data stored by the database(s) 708 may be organized and queried using various criteria including any type of data stored by them, such as the data in the data store 120 and other data discussed herein. The database(s) 708 may include file systems, data tables, documents, databases, or other organized collections of data. Examples of the types of data stored by the database(s) 708 may include the data described herein, for example, in reference to the data store 120.

The database(s) 708 may be included in the computing system 700 or in another computing system and/or storage system distinct from but coupled to or accessible by the computing system 700. The database(s) 708 can include one or more non-transitory computer-readable mediums for storing the data. In some implementations, the database(s) 708 may be incorporated with the memory 706 or may be distinct therefrom. In some implementations, the database(s) 708 may store data associated with a database management system (DBMS) operable on the computing system 700. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

It should be noted that the components described herein may be further delineated or changed without departing from the techniques described herein. For example, the processes described throughout this disclosure may be performed by fewer, additional, or different components.

It should be understood that the methods described herein are provided by way of example, and that variations and combinations of these methods, as well as other methods, are contemplated. For example, in some implementations, at least a portion of one or more of the methods represent various segments of one or more larger methods and may be concatenated or various steps of these methods may be combined to produce other methods which are encompassed by the present disclosure. Additionally, it should be understood that various operations in the methods are iterative, and thus repeated as many times as necessary generate the results described herein. Further the ordering of the operations in the methods is provided by way of example and it should be understood that various operations may occur earlier and/or later in the method without departing from the scope thereof.

In the above description, for purposes of explanation, numerous specific details are set forth in order to provide a thorough understanding of the present disclosure. However, it should be understood that the technology described herein can be practiced without these specific details in various cases. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms such as “processing,” “computing,” “calculating,” “determining,” “displaying,” or the like, refer to the action and methods of a computer system that manipulates and transforms data represented as physical (electronic) quantities within the computer system's registers and memories into other data similarly represented as physical quantities within the computer system memories or registers or other such information storage, transmission or display devices.

A data processing system suitable for storing and/or executing program code, such as the computing system and/or devices discussed herein, may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input or I/O devices can be coupled to the system either directly or through intervening I/O controllers. The data processing system may include an apparatus may be specially constructed for the required purposes, or it may comprise a general-purpose computer selectively activated or reconfigured by a computer program stored in the computer.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects may not be mandatory or significant, and the mechanisms that implement the specification or its features may have different names, divisions, and/or formats.

Furthermore, the modules, routines, features, attributes, methodologies, and other aspects of the disclosure can be implemented as software, hardware, firmware, or any combination of the foregoing. The technology can also take the form of a computer program product accessible from a computer-usable or computer-readable medium providing program code for use by or in connection with a computer or any instruction execution system. Wherever a component, an example of which is a module or engine, of the specification is implemented as software, the component can be implemented as a standalone program, as part of a larger program, as a plurality of separate programs, as a statically or dynamically linked library, as a kernel loadable module, as firmware, as resident software, as microcode, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A computer-implemented method comprising:
transporting, by one or more processors, a first set of mobile storage units from a storage area to an active picking bay of a robotic picking station, the robotic picking station including a robotic arm, the active picking bay being within a range of motion of the robotic arm;
transporting, by the one or more processors, a carton to the robotic picking station;
instructing, by the one or more processors, the robotic arm to move a first item from the first set of mobile storage units into the carton; and
transporting, by the one or more processors, the carton out of the robotic picking station.

2. The computer-implemented method of claim 1, further comprising:
determining an order containing one or more items in the first set of mobile storage units, the one or more items including the first item; and
associating the order with an identifier of the carton based on the first item.

3. The computer-implemented method of claim 1, wherein transporting the first set of mobile storage units from the storage area to the active picking bay of the robotic picking station includes:
transporting, by one or more automated guided vehicles, a second set of mobile storage units from the storage area to a staging area nearer to the active picking bay than the storage area, the staging area being outside the range of motion of the robotic arm; and
transporting, by the one or more automated guided vehicles, the first set of mobile storage units from the staging area to the active picking bay, the first set of mobile storage units being a subset of the second set of mobile storage units.

4. The computer-implemented method of claim 1, wherein:
transporting the carton to the robotic picking station includes transporting an unassigned carton to a carton receiving area at the robotic picking station using one or more conveyors; and
the method includes:
identifying a carton identifier on the unassigned carton upon the unassigned carton arriving at the carton receiving area of the robotic picking station; and
assigning the unassigned carton to an order associated with the first item using the robotic arm, the carton receiving the first item being the previously unassigned carton.

5. The computer-implemented method of claim 4, further comprising:
after transporting the carton out of the robotic picking station, scanning the carton identifier and determining the order assigned to the carton; and
automatically printing a shipping label associated with the order for the carton based on the scan.

6. The computer-implemented method of claim 4, wherein transporting the carton to the robotic picking station includes:
placing the carton on a first conveyor at a carton erector; and
moving the carton from the first conveyor to the carton receiving area using a second conveyor.

7. The computer-implemented method of claim 6, wherein transporting the carton out of the robotic picking station includes:
reversing a direction of the second conveyor to move the carton from the carton receiving area to a third conveyor; and
transporting the carton away from the robotic picking station using the third conveyor.

8. The computer-implemented method of claim 1, further comprising:
determining a set of orders associated with a set of items; the set of items being stored in the storage area in the first set of mobile storage units;
selecting an order from the set of orders containing the first item and associating the order with the carton at the robotic picking station; and
instructing the robotic arm to move a second item associated with the selected order from the first set of mobile storage units into the carton.

9. The computer-implemented method of claim 1, further comprising:
scanning the carton at a carton receiving area adjacent to the robotic arm;
scanning the first item retrieved from a first mobile storage unit;
confirming an identity of the first item based on the scan of the first item; and
instructing the robotic arm to place the first item into the carton based on confirming the identity of the first item.

10. A system comprising:
a robotic arm;
one or more active picking bays within a range of motion of the robotic arm, the one or more active picking bays supplying a first item to be picked by the robotic arm;
a carton receiving area that holds a carton, the robotic arm being configured to pick the first item from the one or more active picking bays and place the first item into the carton in the carton receiving area; and
one or more conveyors conveying the carton to the carton receiving area and conveying the carton from the carton receiving area after the carton has received the first item using the robotic arm.

11. The system of claim 10, further comprising:
a staging area holding one or more mobile storage units as a buffer for the one or more active picking bays, at least a portion of the staging area being outside the range of motion of the robotic arm.

12. The system of claim 11, further comprising:
a storage area storing the one or more mobile storage units, the storage area being farther away from the robotic arm than the staging area.

13. The system of claim 12, further comprising:
one or more automated guided vehicles moving the one or more mobile storage units between the storage area and the staging area.

14. The system of claim 13, wherein:
the one or more automated guided vehicles further move the one or more mobile storage units between the staging area and the one or more active picking bays.

15. The system of claim 10, wherein the one or more conveyors include:
a first conveyor conveying the carton to the carton receiving area; and
a second conveyor conveying the carton from the carton receiving area to a finalizing area.

16. The system of claim 15, wherein the one or more conveyors include:
a third conveyor conveying the carton from the first conveyor to the carton receiving area, the third conveyor being reversible to move the carton away from the carton receiving area.

17. The system of claim 10, further comprising:
one or more scanners at the carton receiving area, the one or more scanners scanning a carton identifier on the carton to identify the carton at the carton receiving area.

18. The system of claim 10, wherein the one or more active picking bays include:
a first shelf on a first side of the robotic arm holding a first mobile storage unit, the first mobile storage unit storing a first plurality of items; and
a second shelf on a second side of the robotic arm holding a second mobile storage unit, the second mobile storage unit holding a second plurality of items.

19. The system of claim 10, wherein:
the one or more active picking bays include two or more shelves each holding a mobile storage unit within the range of motion of the robotic arm, the two or more shelves being horizontally located adjacent to each other; and
a plurality of vertically oriented shelves adjacent to the two or more shelves, the plurality of vertically oriented shelves holding a plurality of mobile storage units outside of the range of motion of the robotic arm.

20. A system comprising:
one or more processors; and
a non-transitory memory storing instructions that, when executed by the one or more processors cause the system to perform operations including:
transporting a first set of mobile storage units from a storage area to an active picking bay of a robotic picking station, the robotic picking station including a robotic arm, the active picking bay being within a range of motion of the robotic arm;
transporting a carton to the robotic picking station;
instructing the robotic arm to move a first item from the first set of mobile storage units into the carton; and
transporting the carton out of the robotic picking station.
